(19) United States
(12) Patent Application Publication
(10) Pub. No.: US 2024/0364631 A1
(43) Pub. Date: Oct. 31, 2024

(54) VXLAN Traffic Handling for EVPN E-Tree

(71) Applicant: Arista Networks, Inc., Santa Clara, CA (US)

(72) Inventors: Akhil Shashidhar, Cedar Park, TX (US); Aaron David Bamberger, Austin, TX (US)

(21) Appl. No.: 18/591,810

(22) Filed: Feb. 29, 2024

Related U.S. Application Data
(60) Provisional application No. 63/499,069, filed on Apr. 28, 2023.

(51) Int. Cl. H04L 45/76; H04L 12/46

(52) U.S. Cl. CPC H04L 45/76; H04L 12/4675

(57) ABSTRACT

An EVPN network device may convey broadcast, unknown unicast, or multicast (BUM) traffic to one or more peer EVPN network devices. The BUM traffic may be encapsulated with a VXLAN header containing an indication of the EVPN role classification (e.g., leaf or root) of the source host of the BUM traffic. The indication may be a value of a leaf indication flag and/or may be a VXLAN network identifier associated with root-sourced or leaf-sourced traffic.

This application claims the benefit of U.S. provisional application No. 63/499,069, filed Apr. 28, 2023, which is hereby incorporated by reference herein in its entirety.

### BACKGROUND

This relates to network devices, and more particularly, to network devices that handle traffic for implementing EVPN E-Tree.

In providing EVPN E-Tree service, provider edge devices can each be attached to root-designated host(s) and/or leaf-designated host(s). Traffic from a root-designated host should be able to reach other root-designated hosts and leaf-designated hosts, whereas traffic from a leaf-designated host should be able to reach root-designated hosts but unable to reach other leaf-designated hosts.

### BRIEF DESCRIPTION OF THE DRAWINGS

FIG. 1 is a diagram of an illustrative network having one or more edge network devices in accordance with some embodiments.

FIG. 2 is a diagram of an illustrative network device in accordance with some embodiments.

FIG. 3 is a diagram of an illustrative network configuration with edge network devices coupled to root-designated and/or leaf-designated hosts in accordance with some embodiments.

FIG. 4 is a diagram of illustrative VXLAN BUM traffic being conveyed between edge network devices in accordance with some embodiments.

FIG. 5 is a diagram of an illustrative association between a local VLAN and multiple VNIs for E-Tree service in accordance with some embodiments.

FIG. 6 is a diagram of an illustrative leaf VNI advertisement message in accordance with some embodiments.

FIG. 7 is a diagram of illustrative egress edge device processing of leaf-sourced VXLAN BUM traffic based on a leaf VNI in accordance with some embodiments.

FIG. 8 is a diagram of illustrative egress edge device processing of root-sourced VXLAN BUM traffic based on a root VNI in accordance with some embodiments.

FIG. 9 is a diagram of illustrative ingress edge device processing of leaf-sourced VXLAN BUM traffic based on a leaf VNI floodlist in accordance with some embodiments.

FIG. 10 is a diagram of illustrative egress edge device processing of leaf-sourced VXLAN BUM traffic based on a set leaf indication flag in accordance with some embodiments.

FIG. 11 is a diagram of illustrative egress edge device processing of root-sourced VXLAN BUM traffic based on an unset leaf indication flag in accordance with some embodiments.

FIG. 12 is a diagram of an illustrative network configuration with gateways for respective sites connected via a corresponding interconnect network in accordance with some embodiments.

FIG. 13 is a flowchart of illustrative operations for providing E-Tree service for VXLAN traffic in accordance with some embodiments.

### DETAILED DESCRIPTION

A network can convey network traffic (e.g., in the form of one or more packets, one or more frames, etc.) between hosts. To properly forward the network traffic, the network can include a number of network devices. Some of these network devices may implement an Ethernet Virtual Private Network (EVPN) process and may exchange address reachability information represented by EVPN route information with one another and process the exchanged information. These network devices are sometimes referred to herein as EVPN devices or EVPN peer network devices.

Configurations in which the exchange of EVPN route information (e.g., hardware address reachability information) occurs using Border Gateway Protocol (BGP), or more specifically Multiprotocol BGP (MP-BGP), and/or with Virtual Extensible Local Area Network (VXLAN) (e.g., using EVPN network devices configured to process network traffic with VXLAN headers) are sometimes described herein as illustrative examples. If desired, the exchange of hardware address reachability information can occur with other types of control plane routing protocol and utilize other types of underlying network infrastructure.

For some applications, it may be desirable to implement a network segmentation technology such as EVPN Ethernet-Tree (E-Tree) using EVPN devices. Unlike with Multiprotocol Label Switching (MPLS) infrastructure in which one or more MPLS labels may be used to classify traffic (e.g., as leaf-sourced traffic or as root-sourced traffic) to facilitate network segmentation, a network implementing VXLAN infrastructure may be unable to use the same techniques to facilitate communication of local host role classification (e.g., as root or leaf) between EVPN devices. This is especially troublesome for network configurations in which hosts coupled to the same EVPN device can include both leaf-designated hosts and root-designated hosts.

To allow for the exchange of local host role classification and thereby facilitate the use of segmentation technologies such as EVPN E-Tree with VXLAN infrastructure, an EVPN device may be configured to associate multiple virtual network identifiers (VNIs, which are sometimes referred to as VXLAN network identifiers) to a single local VLAN such as a default (root) VNI and an additional (leaf) VNI. The EVPN device may advertise, to peer EVPN devices, a route containing the leaf VNI, a VLAN identifier (VID) identifying the local VLAN, and a E-Tree extended community indicative of the leaf classification of the VNI and its association with the local VLAN. Based on the reception and processing of this route, the peer EVPN devices may implement proper segmentation for network traffic such as VXLAN broadcast, unknown unicast, and/or multicast (BUM) traffic subsequently received from the EVPN device. If desired, instead of or in addition to the use of the root and leaf VNIs in the VXLAN BUM traffic, EVPN devices may implement proper segmentation based on a flag value (e.g., the flag being set or unset) in the VXLAN header of the VXLAN BUM traffic to indicate role classification of the host originating the traffic.

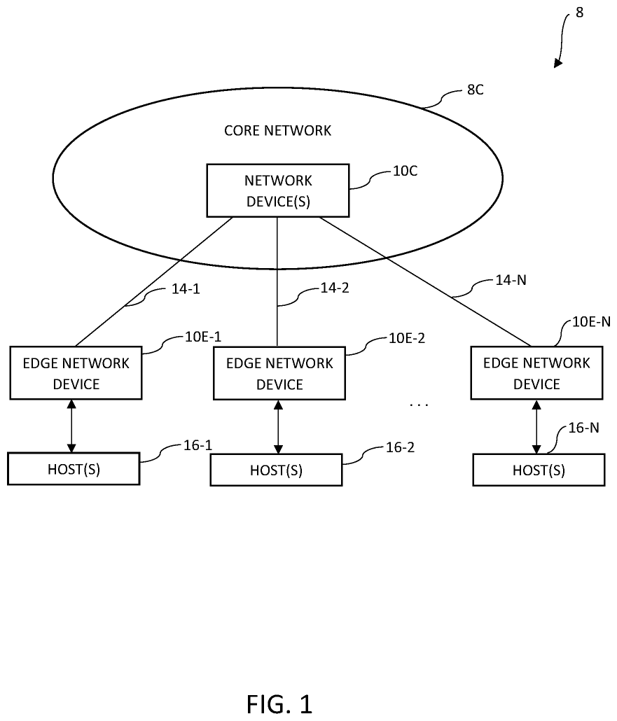

An illustrative networking system in which EVPN devices implement a network segmentation technology such as EVPN E-Tree is shown in FIG. 1. A network such as network 8 may be of any suitable scope and/or form part of a larger network of any suitable scope. As examples, network 8 may include, be, and/or form part of one or more local segments, one or more local subnets, one or more local area networks (LANs), one or more campus area networks, a wide area network, etc. Network 8 may include any suitable number of different network devices that connect corresponding host devices of network 8 to one another. If desired, network 8 may include or be coupled to internet service provider networks (e.g., providing connectivity for the Internet) or other public service provider networks, private service provider networks (e.g., multiprotocol label switching (MPLS) networks), and/or other types of networks such as telecommunication service provider networks (e.g., a cellular network).

As shown in FIG. 1, network 8 may include a core network or core network portion 8C interconnecting different edge networks or edge network portions (e.g., different sites and/or different domains). As one illustrative example, core network portion 8C may form a backbone network such as a service provider network (e.g., an Internet or Internet Protocol (IP) service provider network, a Multiprotocol Label Switching (MPLS) infrastructure network, a cloud provider network, or generally a communication network core). Core network portion 8C may connect different edge network portions belonging to entities (e.g., customers) different from (or the same as) those that provide core network portion 8C. In configurations in which network devices implement one or more EVPN instances over core network portion 8C, core network portion 8C may sometimes be referred to herein as an EVPN core or generally an underlay network.

Core network devices 10C may sometimes be referred to as provider (network) core devices whereas edge network devices 10E may sometimes be referred to as provider (network) edge devices. Core network portion 8C may include core network devices 10C that are interconnected with each other within core portion 8C. Network paths 14 (e.g., one or more paths 14-1, one or more paths 14-2, . . . , one or more paths 14-N) couple one or more core network devices 10C to edge network devices 10E (e.g., devices 10E-1, 10E-2, . . . , 10E-N) that serve as interfaces between the core network devices 10C and the edge network portions. These edge network portions (e.g., sites) may each include its own set of hosts 16 (e.g., hosts 16-1, 16-2, . . . , 16-N) and its own set of network devices (not explicitly shown in FIG. 1) between host(s) 16 and a corresponding edge network device 10E.

Network devices in network 8 such as provider edge network devices 10E, provider core network devices 10C, and network devices in the edge network portions may each include or be a switch (e.g., a single-layer (Layer 2) switch or a multi-layer (Layer 2 and Layer 3) switch), a bridge, a router, a gateway, a hub, a repeater, a firewall, a wireless access point, a network device serving other networking functions, a network device that includes the functionality of two or more of these devices, a management device that controls the operation of one or more of these network devices, and/or other types of network devices. Configurations in which provider edge network devices 10E-1, 10E-2, . . . , 10E-N are (multi-layer) switches, routers, gateways, or network devices that generally include routing functionalities (e.g., implements routing protocols) are described herein as an example.

Hosts 16 may be implemented on host devices or host equipment. Some hosts may be implemented on a shared host device or shared host equipment, while other hosts may each be implemented on a separate host device or a separate piece of host equipment. Different host devices or host equipment in network 8 (e.g., hosts in the edge network portions or sites) serving as end hosts of network 8 may each include or be a computer, a server or server equipment, a portable electronic device such as a cellular telephone, a laptop, etc., a network traffic storage device, a networking service device, network management equipment that manages and controls the operation of one or more of hosts and/or network devices, and/or any other suitable types of specialized or general-purpose host computing equipment, e.g., running one or more client-side and/or server-side applications.

Networking equipment (e.g., network devices and devices or equipment on which hosts are implemented) in network 8 may be connected by one or more wired technologies or standards such as Ethernet (e.g., using copper cables and/or fiber optic cables), thereby forming a wired network portion of network 8 (e.g., including core network portion 8C and portions of edge network portions). If desired, network 8 may also include one or more wireless network portions (e.g., implemented using wireless access points) that extend from the wired network portion.

In some configurations described herein as an example, edge network devices 10E may implement an EVPN over core network 8C, and accordingly, may be referred to as EVPN peer devices with respect to each other. In these illustrative configurations, the EVPN peer devices may exchange EVPN route information (e.g., hardware address reachability information) with one another over core network 8C. The EVPN route information (e.g., BGP messages containing the EVPN route information) may be exchanged based on any suitable underlying (transport layer and internet layer) protocol(s) that facilitate communication across underlay network 8C. The underlay network 8C (and the devices herein) may provide and implement underlying infrastructure over which the overlay VXLAN-based and/or MPLS-based network is implemented.

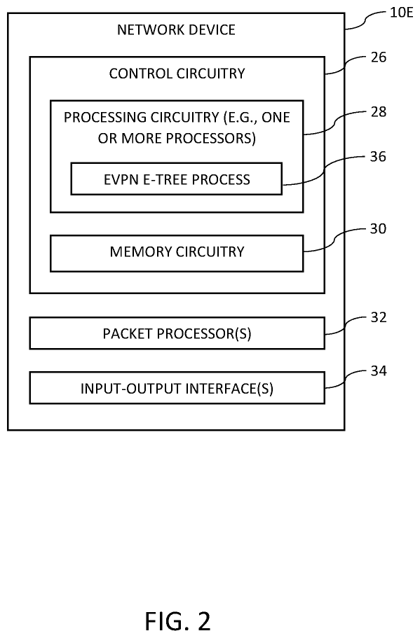

FIG. 2 is a diagram of an illustrative EVPN network device (e.g., each of edge network devices 10E-1, 10E-2, . . . , 10E-N) configured to exchange EVPN route information with other EVPN peer devices. If desired, other network devices such as network devices 10C (FIG. 1), (customer) site edge devices, gateways for sites, spine switches for sites, leaf switches for sites, and/or other network devices connected to the edge network devices may have at least some (e.g., all) of the same components as the network device depicted in FIG. 2 but may omit execution of a EVPN process and/or a network segmentation technology process, such as a EVPN E-Tree process, at the processing circuitry.

As shown in FIG. 2, network device 10E may include control circuitry 26 having processing circuitry 28 and memory circuitry 30, one or more packet processors 32, and input-output interfaces 34 disposed within a housing of network device 10E. In one illustrative arrangement, network device 10E may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10E may be a fixed-configuration network device (e.g., a fixed-configuration switch having a fixed number of ports and/or a fixed hardware configuration).

Processing circuitry 28 may include one or more processors or processing units based on central processing units (CPUs), based on graphics processing units (GPUs), based on microprocessors, based on general-purpose processors, based on host processors, based on microcontrollers, based on digital signal processors, based on programmable logic devices such as a field programmable gate array (FPGA) device, based on application specific system processors (ASSPs), based on application specific integrated circuit (ASIC) processors, and/or based on other processor architectures.

Processing circuitry 28 may run (e.g., execute) a network device operating system and/or other software/firmware that is stored on memory circuitry 30. Memory circuitry 30 may include non-transitory (tangible) computer-readable storage media that stores the operating system software and/or any other software code, sometimes referred to as program instructions, software, data, instructions, or code. As an example, the EVPN routing functions performed by network device 10E described herein may be stored as (software) instructions on the non-transitory computer-readable storage media (e.g., in portion(s) of memory circuitry 30 in network device 10E). The corresponding processing circuitry (e.g., one or more processors of processing circuitry 28 in network device 10E) may process or execute the respective instructions to perform the corresponding EVPN routing functions. Memory circuitry 30 may be implemented using non-volatile memory (e.g., flash memory or other electrically-programmable read-only memory configured to form a solid-state drive), volatile memory (e.g., static or dynamic random-access memory), hard disk drive storage, removable storage devices (e.g., storage device removably coupled to device 10E), and/or other storage circuitry. Processing circuitry 28 and memory circuitry 30 as described above may sometimes be referred to collectively as control circuitry 26 (e.g., implementing a control plane of network device 10E).

As just a few examples, processing circuitry 28 may execute network device control plane software such as operating system software, routing policy management software, routing protocol agents or processes (e.g., EVPN and E-Tree service process 36), routing information base agents, and other control software, may be used to support the operation of protocol clients and/or servers (e.g., to form some or all of a communications protocol stack), may be used to support the operation of packet processor(s) 32, may store packet forwarding information, may execute packet processing software, and/or may execute other software instructions that control the functions of network device 10E and the other components therein.

Packet processor(s) 32 may be used to implement a data plane or forwarding plane of network device 10E. Packet processor(s) 32 may include one or more processors or processing units based on central processing units (CPUs), based on graphics processing units (GPUs), based on microprocessors, based on general-purpose processors, based on host processors, based on microcontrollers, based on digital signal processors, based on programmable logic devices such as a field programmable gate array (FPGA) device, based on application specific system processors (ASSPs), based on application specific integrated circuit (ASIC) processors, and/or based on other processor architectures.

Packet processor 32 may receive incoming network traffic via input-output interfaces 34, parse and analyze the received network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on a portion of memory circuitry 30 and/or other memory circuitry integrated as part of or separate from packet processor 32.

Input-output interfaces 34 may include different types of communication interfaces such as Ethernet interfaces (e.g., implemented over one or more Ethernet ports), optical interfaces, wireless interfaces such as Bluetooth interfaces and Wi-Fi interfaces, and/or other communication interfaces for connecting network device 10E to the Internet, a local area network, a wide area network, a mobile network, and/or generally other network device(s), peripheral devices, and computing equipment (e.g., host equipment such as server equipment, client devices, etc.). As an example, input-output interfaces 34 may be implemented using and therefore include ports to which corresponding mating connectors of external components can be physically coupled and electrically connected. Ports may have different form-factors to accommodate different cables, different modules, different devices, or generally different external equipment. If desired, input-output interfaces 34 (e.g., wireless interfaces) may be implemented using and therefore include wireless communication circuitry (e.g., antennas, transceivers, radios, etc.).

Configuration in which some network devices in network 8 (e.g., network devices 10E in FIGS. 1 and 2) provide an EVPN and a network segmentation service such as an E-Tree service over the EVPN (e.g., using processes 36 executing on corresponding processing circuitry of respective EVPN network devices) are sometimes described herein as an illustrative example. EVPN process 36 may manage and facilitate operations for an EVPN such as the exchange of EVPN route information with other peer devices and the handling and processing of the exchanged information. The E-Tree service portion of process 36 may help implement a network segmentation service by determining the root or leaf classification of local hosts and/or remote hosts and processing traffic between local and remote hosts of different role classifications based on segmentation policy or rules.

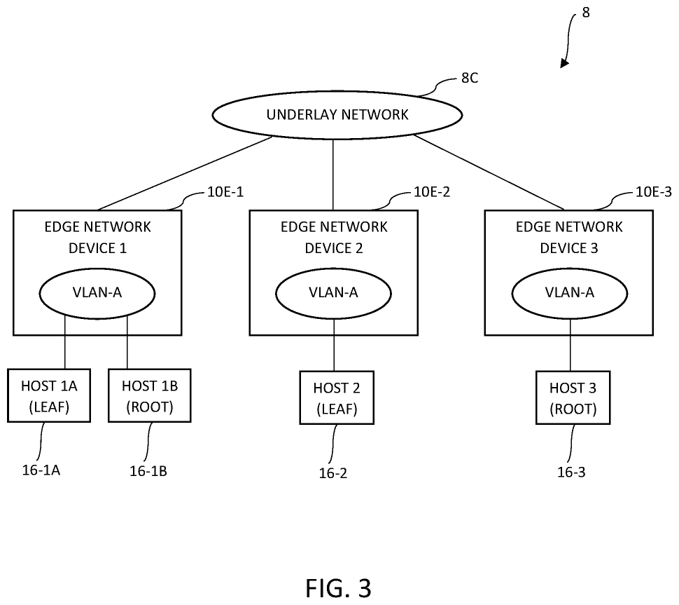

FIG. 3 shows an illustrative network configuration having network devices 10E-1, 10E-2, and 10E-3 (e.g., three of network devices 10E in FIG. 1) that provide EVPN E-Tree service. In particular, edge network devices 10E-1, 10E-2, and 10E-3 may each execute an EVPN E-tree service process 36 (e.g., executing on corresponding processing circuitry 28 of device 10E of FIG. 2).

Edge devices 10E-1, 10E-2, and 10E-3 may provide one or more EVPN instances that are attached to (e.g., communicatively coupled to or simply coupled to) root hosts and/or leaf hosts. Each EVPN instance can contain one or more Layer 2 (L2) broadcast domains (e.g., VLANs). Leaf or root designations (sometimes referred to as EVPN role classifications) may be provided on a per (provider) edge device basis, may be provided on a per attachment circuit (e.g., per VLAN) basis, and/or may be provided on a per host (e.g., per MAC address) basis. Configurations in which leaf or root designations are provided on a per host basis are sometimes described herein as illustrative examples. In these examples, hosts of different designations (e.g., both leaf hosts and root hosts) may belong to the same local VLAN and may be coupled to the same provider edge device.

In the example of FIG. 3, edge devices 10E-1, 10E-2, and 10E-3 are configured to implement an illustrative EVPN instance such as an EVPN instance based on a VLAN based service for a VLAN (e.g., a VLAN identified by VLAN identifier VLAN-A). To implement the EVPN instance, edge network device 10E-1 may be coupled to and attached to a first site containing one or more end hosts such as hosts 16-1A and 16-1B on (e.g., as members of, belonging to, etc.) the VLAN identified by VLAN-A. End host 16-1A may be designated and configured at device 10E-1 as a leaf host, while end host 16-1B may be designated and configured at device 10E-2 as a root host.

To implement the EVPN instance for the VLAN of VLAN-A, edge network device 10E-2 may be coupled to and attached to a second site containing one or more end hosts such as host 16-2 on (e.g., as a member of, belonging to, etc.) VLAN-A. End host 16-2 may be designated and configured at device 10E-2 as a leaf host.

To implement the EVPN instance for the VLAN of VLAN-A, edge network device 10E-3 may be coupled to and attached to a third site containing one or more end hosts such as host 16-3 on (e.g., as a member of, belonging to, etc.) VLAN-A. End host 16-3 may be designated and configured at device 10E-3 as a root host.

While the sites coupled to or generally attached to edge network devices 10E-1, 10E-2, and 10E-3 are shown in FIG. 3 to contain only hosts, this is merely illustrative. If desired, these sites may include network devices (e.g., gateways, routers, switches, and/or other suitable types of network devices) coupled between the edge devices and the corresponding hosts and/or may include additional hosts.

While the example of FIG. 3 illustrates a network configuration in which the edge devices 10E-2 and 10E-3 are each coupled to host(s) of the same designation (leaf or root), this is merely illustrative. If desired, edge devices 10E-2 and/or 10E-3 may be coupled to hosts of mixed designations (similar to edge device 10E-1). While the example of FIG. 3 illustrates a network configuration in which the EVPN instance is provided for a given VLAN, this is merely illustrative. If desired, one or more EVPN instances may be provided for other VLANs or for VLAN bundles (e.g., a VLAN-aware bundle containing multiple VLANs). As an example, hosts 16-1A, 16-1B, 16-2, and 16-3 may be configured at respective edge devices as part of the same VLAN bundle.

To provide EVPN E-Tree service, edge network devices 10E-1, 10E-2, and 10E-3 may be configured to enforce appropriate network segmentation between different leaf and root hosts. Each edge network device 10E may advertise EVPN routes using messages conveyed through underlay network 8C to the other peer edge devices 10E. Each edge network device 10E may receive and process these advertised EVPN routes from the other peer edge network devices 10E to determine the designation of remote hosts and thereby enforce appropriate segmentation (e.g., by appropriate forwarding and dropping traffic) based on root and leaf designations.

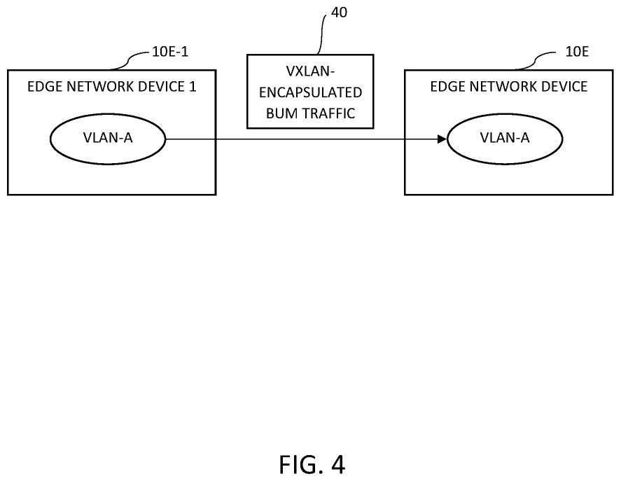

It may be desirable to provide E-Tree service for various types of network configurations such as core networks that employ VXLAN infrastructure. To properly implement E-Tree service, it may be desirable for edge network devices to appropriately handle BUM (broadcast, unknown unicast, and/or multicast) traffic, which may be more complex than the handling of unicast traffic. In some configurations described herein as an illustrative example, underlay network 8C may implement VXLAN infrastructure (e.g., a VXLAN overlay) and VXLAN tunnels may be constructed over underlay network 8C. In particular, FIG. 4 is a diagram of illustrative traffic that may be forwarded between peer edge network devices 10E (e.g., via underlay network 8C in FIG. 3).

As shown in FIG. 4, a given edge network device such as device 10E-1 may convey network traffic such as network packets each with a VXLAN header (sometimes referred to herein as VXLAN-encapsulated packets or VXLAN-encapsulated traffic) to another edge network device 10E (e.g., device 10E-2 and/or 10E-3). Illustrative configurations in which the conveyed traffic includes BUM traffic 40 are described herein as examples. While not explicitly shown in FIG. 4, traffic 40 may be conveyed across network 8C which provides appropriate handling for VXLAN-encapsulated traffic. If desired, the conveyed traffic may include unicast traffic in addition to BUM traffic 40.

While suitable mechanisms for implementing E-Tree service in which the underlay network provides MPLS infrastructure exist, mechanisms for implementing E-Tree service for VXLAN infrastructure, especially for the handling of BUM traffic, may be lacking. In particular, while MPLS labels may be used to facilitate exchange of host designation information as part of EVPN routes, analogous labels may not exist when using VXLAN infrastructure.

Accordingly, to provide suitable handling of VXLAN traffic, edge network devices 10E may be configured to handle VXLAN traffic with source host designation information in the VXLAN header that is indicative of root(-host)-sourced traffic or leaf(-host)-sourced traffic. In one illustrative arrangement, the source host designation information may be carried as part of the virtual network identifier in the VXLAN header.

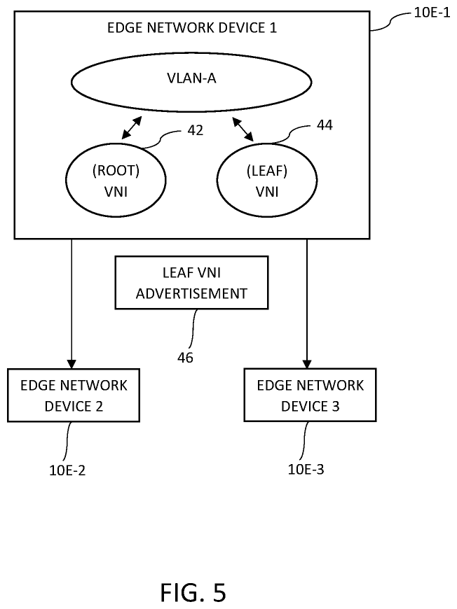

In particular, FIG. 5 shows an illustrative configuration for an edge network device such as edge network device 10E-1 attached to hosts of mixed designations (e.g., leaf host 16-1A and root host 16-1B). Hosts 16-1A and 16-1B may both belong to the same VLAN (e.g., having VLAN identifier (VID) VLAN-A). Network device 10E-1 may be configured to associate multiple VNIs with the same VLAN.

As shown in FIG. 5, network device 10E-1 may be configured with a first VNI such as a default or root VNI 42 and a second VNI such as an additional or leaf VNI 44. These VNIs may be configured dynamically (e.g., in response to the configuration of the VLAN of VLAN-A, in response to configuration of hosts having mixed designations, and/or in response to other criteria being met) and/or may be configured manually (e.g., based on user input).

To prepare remote edge devices for the handling of locally sourced traffic, edge network device 10E-1 may advertise VNI 44 and an indication of VNI 44 as the leaf VNI to the other peer network devices (e.g., devices 10E-2 and 10E-3). As such, based on the reception and processing of such an advertisement message, the peer network devices may configure themselves to appropriately handle VXLAN traffic carrying VNI 44 in its VNI field.

In the example of FIG. 5, network device 10E-1 may broadcast an advertisement message such as leaf VNI message 46 toward edge network devices 10E-2 and 10E-3. Advertisement message 46 may include any suitable information for indicating an VNI, its association with a particular VLAN, and/or the (leaf) designation of the VNI. Arrangements in which an EVPN route advertisement message is used to convey this type of leaf VNI information are sometimes described herein as an illustrative example. If desired, network device 10E-1 may convey one or more other types of advertisement messages (e.g., to convey root VNI information, to convey additional leaf VNIs, etc.) instead of or in addition to advertisement message 46 containing the leaf VNI information.

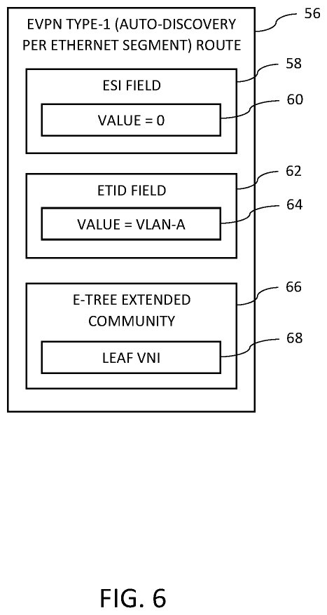

FIG. 6 shows an illustrative EVPN type-1 route (sometimes referred to herein as an EVPN auto-discovery or A-D route) that may be altered to convey leaf VNI information. This type of route may be advertised as part of an advertisement message (e.g., message 46) conveyed to edge network devices 10E-2 and 10E-3. In the example of FIG. 6, EVPN type-1 route 56 may be advertised on a per Ethernet segment basis and may include an Ethernet segment identifier (ESI) field such as ESI field 58, an Ethernet tag identifier field (ETID) such as ETID field 62, an E-Tree extended community such as E-Tree extended community 66, among other fields and/or other types of information.

Rather than carrying the typical values and/or information designated for these fields, an advertisement message for this EVPN type-1 per Ethernet segment route may be altered to contain E-tree role classification information. In particular, ESI field 58 may carry zero (rather than a non-zero value denoting the Ethernet segment for which the EVPN type-1 route is advertised) as ESI value 60. By generating EVPN route 56 with zero as value 60 for field 58, the sending or advertising device (e.g., device 10E-1 in FIG. 5) may indicate to other peer devices (e.g., devices 10E-2 and 10E-3 in FIG. 5) that the route being advertised is a special route reserved for providing E-Tree role classification information.

Furthermore, ETID field 62 may include, as its value, the identifier of the local VLAN of the advertising edge device for which the leaf VNI is being conveyed (rather than an Ethernet tag identifier value). Using the example of FIG. 5, field 62 may contain VLAN identifier (VID) VLAN-A as ETID value 64. E-Tree extended community 66 may contain the leaf VNI 68 (e.g., VNI 44 in FIG. 5 associated with the local VLAN of VLAN-A) as the value in a field in extended community 66 (e.g., a leaf-label field in extended community 66).

Edge network device 10E-1 may generate an advertisement message (e.g., BGP message) containing route 56 and may send the message to peer network devices 10E-2 and 10E-3 across underlay network 8C. Upon peer network devices (e.g., network device 10E-2 and/or 10E-3) receiving the advertisement message, the peer network devices may similarly associate the leaf VNI with the corresponding VLAN (e.g., identified by VID VLAN-A) and generate traffic forwarding information to enforce E-Tree segmentation based on the leaf VNI. In other words, network traffic associated with VID VLAN-A and containing the leaf VNI may be determined by the remote peer network device to be leaf-sourced traffic (e.g., traffic that originated from a remote host designated as a leaf host).

In configurations described herein as an illustrative example, advertisement of the default root VNI by device 10E-1 may be omitted. As such, network traffic associated with VID VLAN-A and containing the root VNI (e.g., any VNI other than the advertised leaf VNI) may be determined by the remote peer network device to be root-sourced traffic (e.g., traffic that originated from a remote host designated as a root host).

If desired, the root VNI may be advertised and processed instead of or in addition to the leaf VNI. In other words, the remote peer network devices, after processing the advertised route (e.g., in a BGP advertisement message such as a message containing an altered EVPN type-1 route) indicating the root VNI and its root designation, may determine any network traffic associated with VID VLAN-A and containing the root VNI is root-sourced traffic.

After remote edge network devices 10E (e.g., devices 10E-2 and 10E-3) have received and processed the advertised E-Tree role classification route (e.g., route 56 in FIG. 6 as part of message 46 in FIG. 5), these edge network devices 10E may be configured to properly handle VXLAN BUM traffic from the local edge network device 10E (e.g., device 10E-1).

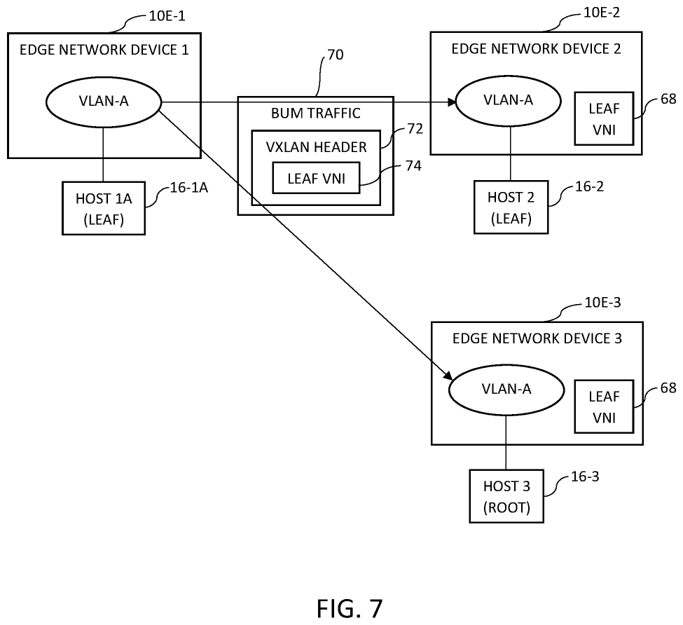

FIG. 7 is a diagram of illustrative traffic handling when BUM traffic originates from a leaf-designated host. In the example of FIG. 7, edge network device 10E-1 may receive traffic such as traffic 70 from leaf-designated host 16-1A. Edge network device 10E-1 may forward traffic 70 toward edge network devices 10E-2 and 10E-3 via network 8C in FIG. 3. In particular, after receiving the traffic from host 16-1A, network device 10E-1 may perform replication of the traffic (sometimes referred to as ingress replication since device 10E-1 is at the ingress side of network 8C) and forward the replicated traffic as traffic 70 to both edge network devices 10E-2 and 10E-3 (and other network devices 10E at the egress side of network 8C).

Based on their locally attached hosts for the same VLAN (e.g., whether one or more local leaf and/or root hosts for the same VLAN are communicatively coupled to the edge device), egress-side edge network devices 10E-2 and 10E-3 may appropriately process (e.g., forward and/or drop) the received BUM traffic 70 to provide segmentation for E-Tree service.

To assist in appropriate processing of BUM traffic 70 at the egress side of network 8C (e.g., at devices 10E-2 and 10E-3), each packet of BUM traffic 70 may include a VXLAN header 70 including or generally identifying leaf VNI 74. In particular, in preparation for traversal across network 8C, network device 10E-1 may perform VXLAN encapsulation for BUM traffic 70 that originated from host 16-1A. Because network device 10E-1 is configured to identify host 16-1A as a leaf-designated host, as part of the encapsulation process, a leaf-indicating VNI (e.g., VNI 74) may be included in the VXLAN header (rather than a default or root-indicating VNI).

Prior to the processing of BUM traffic 70, edge network device 10E-1 may have already advertised leaf VNI 74 to peer edge network devices 10E-2 and 10E-3 (e.g., in the manner described in connection with FIGS. 5 and 6). Accordingly, network devices 10E-2 and 10E-3 may each be configured to store leaf VNI 68 (e.g., the same leaf VNI as advertised by edge network device 10E-1). The advertised leaf VNI 68 may be associated with the advertised VLAN (e.g., identified by VID VLAN-A). In such a manner, when packets encapsulated with the leaf VNI from host(s) on the advertised VLAN are received, egress-side network devices 10E-2 and 10E-3 may be able to identify that these packets originated from a leaf-designated host belonging to the VLAN. In particular, the egress-side network device may perform a lookup operation to identify the particular VLAN associated with the leaf VNI in the encapsulation (e.g., because the VLAN and leaf VNI are advertised in the same route 56 in FIG. 6). Accordingly, the egress-side network device may identify the VLAN and the locally attached host(s) on the VLAN, and may determine whether or not to forward the traffic to the identified locally attached host(s).

In an arrangement in which an egress edge network device is coupled or locally attached to local leaf-designated end host(s), the egress network device may decapsulate the VXLAN-encapsulated traffic and drop leaf-sourced BUM traffic 70 to prevent traffic 70 from reaching local leaf-designated host(s) on the identified VLAN. Accordingly, in the example of FIG. 7, device 10E-2 may receive BUM traffic 70 but may drop the received BUM traffic 70 to prevent BUM traffic 70 from reaching host 16-2. This enforces E-Tree service segmentation in which leaf-host-sourced traffic should not reach leaf-designated destination hosts.

In an arrangement in which an egress edge network device is coupled or locally attached to local root-designated end host(s), the egress network device may decapsulate the VXLAN-encapsulated traffic and forward leaf-sourced BUM traffic 70 to the root-designated end host(s) on the identified VLAN. Accordingly, in the example of FIG. 7, device 10E-3 may receive BUM traffic 70 and may forward the received BUM traffic 70 to host 16-3. This enforces E-Tree service segmentation in which leaf-host-sourced traffic should reach root-designated destination hosts. Since root-designated hosts can receive both leaf-sourced and root-sourced traffic, in a configuration in which edge network device 10E-3 is attached to only root-designated hosts, device 10E-3 may forward BUM traffic 70 without necessarily identifying VNI 74 as a leaf VNI (e.g., insofar as the local VLAN to which the root-designated hosts belongs is identified).

In an arrangement in which an egress network device is coupled or locally attached to both leaf-designated and root-designated local hosts, the egress network device may decapsulate the VXLAN-encapsulated traffic and forward the leaf-sourced BUM traffic 70 to root-designated end host(s) in the identified VLAN while dropping the BUM traffic 70 to prevent traffic 70 from reaching leaf-designated end host(s) in the identified VLAN.

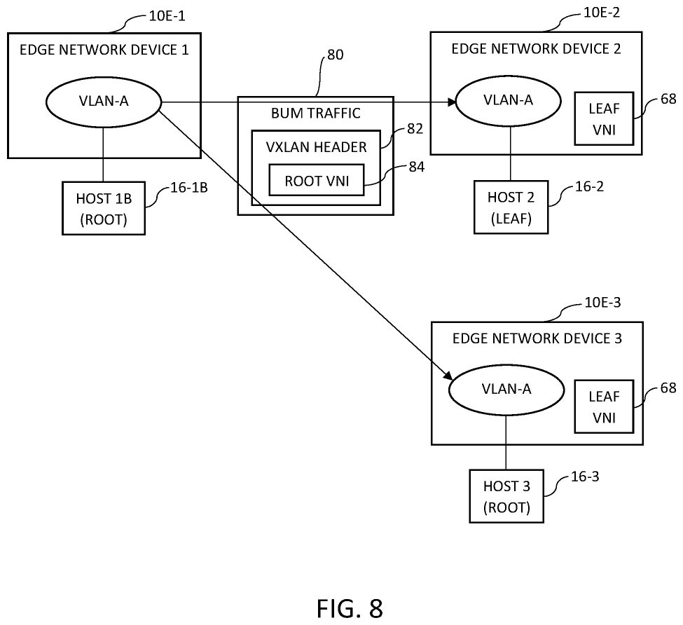

FIG. 8 is a diagram of illustrative traffic handling when BUM traffic originates from a root-designated host. In the example of FIG. 8, edge network device 10E-1 may receive traffic such as traffic 80 from root-designated host 16-1B. Edge network device 10E-1 may forward traffic 80 toward edge network devices 10E-2 and 10E-3 via network 8C in FIG. 3. In particular, after receiving the traffic from host 16-1B, network device 10E-1 may perform replication of the traffic (sometimes referred to as ingress replication since device 10E-1 is at the ingress side of network 8C) and forward the replicated traffic as traffic 80 to both edge network devices 10E-2 and 10E-3 (and other network devices 10E at the egress side of network 8C).

Based on their locally attached hosts for the same VLAN (e.g., whether one or more local leaf and/or root hosts for the same VLAN are communicatively coupled to the edge device), edge network devices 10E-2 and 10E-3 may appropriately process (e.g., forward) the received BUM traffic 80 to provide segmentation for E-Tree service.

To assist in appropriate processing of BUM traffic 80 at the egress side of network 8C (e.g., at devices 10E-2 and 10E-3), each packet of BUM traffic 80 may include a VXLAN header 82 including or generally identifying root VNI 84. In particular, in preparation for traversal across network 8C, network device 10E-1 may perform VXLAN encapsulation for BUM traffic 80 that originated from host 16-1B. Because network device 10E-1 is configured to identify host 16-1B as a root-designated host, as part of the encapsulation process, a root-indicating VNI (e.g., VNI 84) may be included in the VXLAN header (rather than a leaf-indicating VNI 74 in FIG. 7).

Prior to the processing of BUM traffic 80, edge network device 10E-1 may have already advertised leaf VNI 74 to peer edge network devices 10E-2 and 10E-3 (e.g., in the manner described in connection with FIGS. 5 and 6). Accordingly, network devices 10E-2 and 10E-3 may each be configured to store leaf VNI 68 (e.g., the same leaf VNI as advertised by edge network device 10E-1). The advertised leaf VNI 68 may be associated with the advertised VLAN (e.g., identified by VID VLAN-A). In such a manner, when packets encapsulated with the root VNI from host(s) on the advertised VLAN are received, egress-side network devices 10E-2 and 10E-3 may be able to determine that these packets did not originate from a leaf-designated host (e.g., root VNI not matching any previously advertised leaf VNIs, matching previously advertised root VNIs, etc.) and may consequently determine that these packets originated from a root-designated host.

Since traffic originating from root-designated hosts can be received by both leaf-designated and root-designated hosts in the same VLAN, in a configuration in which egress edge network devices (e.g., devices 10E-2 and 10E-3) receive root-designated traffic, the egress network devices may perform a lookup operation based on the root VNI to determine locally attached hosts on the associated local VLAN and may forward the BUM traffic to both leaf and root end hosts on the local VLAN. Accordingly, device 10E-2 may forward BUM traffic 80 to host 16-2 on the VLAN of VLAN-A and device 10E-3 may forward BUM traffic 80 to host 16-3 on the VLAN of VLAN-A (e.g., identified by the lookup operation using the root VNI).

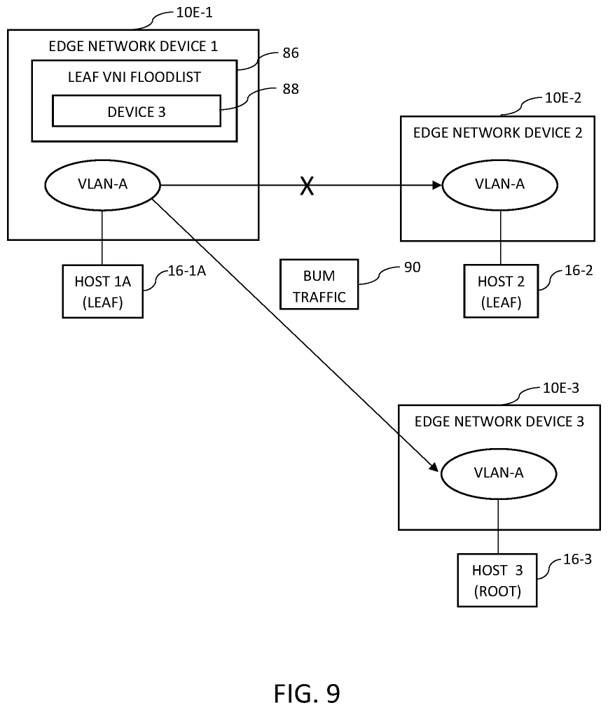

In some instances, a floodlist may be maintained at the ingress edge network device based on leaf VNIs to facilitate appropriate EVPN E-Tree segmentation. In particular, FIG. 9 is a diagram of illustrative traffic handling using a floodlist stored on an ingress edge network device such as device 10E-1.

In the example of FIG. 9, device 10E-1 may be configured to maintain (e.g., generate, store, and/or update) a floodlist such as leaf VNI floodlist 86. Leaf VNI floodlist 86 may store one or more egress-side edge network devices having local attachments to (only) root-designated host(s), to which leaf-source BUM traffic should be forwarded. In some configurations described herein as an example, network device 10E-1 may receive indications of leaf and/or root designations of hosts locally attached to remote (egress-side) edge devices. Based on these indications, device 10E-1 may determine that remote edge device 10E-2 is locally attached to only leaf-designated hosts and remote edge device 10E-3 is locally attached to at least one root-designated host. Accordingly, edge device 10E-1 may populate floodlist 86 with an indication 88 (e.g., identifier 88) of edge device 10E-3 but not an indication of edge device 10E-2 such that local leaf-sourced traffic is filtered to only be forwarded to device 10E-3 but not device 10E-2. This type of filtering may sometimes be referred to as ingress filtering since device 10E-1 (which performs the filtering) is on the ingress side of network 8C through which traffic is conveyed from device 10E-1 to devices 10E-2 and 10E-3.

In other words, leaf-designated host 16-1A may forward BUM traffic 90 to ingress edge device 10E-1. Device 10E-1 may replicate and multicast traffic 90 received from host 16-1A to each egress edge device on leaf VNI floodlist 86. The replicated traffic may be encapsulated for conveyance (across core network 8C) as BUM traffic 90. Device 10E-1 may not forward BUM traffic 90 to device 10E-2 because device 10E-2 is not on floodlist 86. Device 10E-1 may forward BUM traffic 90 to Device 10E-3 because device 10E-3 is on floodlist 86. Device 10E-3 may forward the received traffic to its locally attached root-designated hosts.

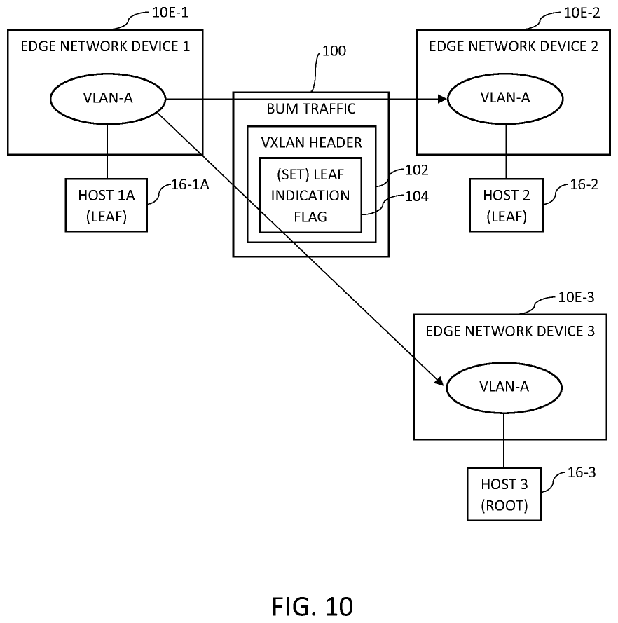

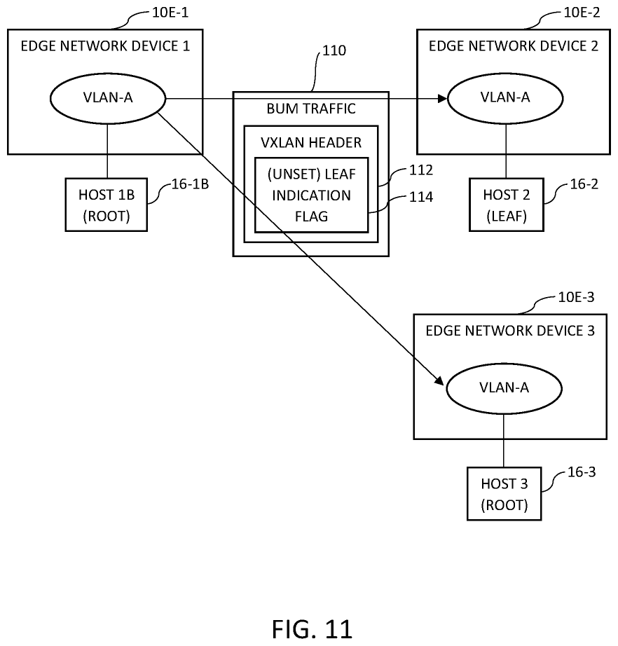

In some instances, VXLAN BUM traffic may include an indication flag in the VXLAN header used to indicate the EVPN role classification of the traffic-originating host. In particular, FIGS. 10 and 11 are diagrams of illustrative traffic handling using such an indication flag.

FIG. 10 is a diagram of illustrative traffic handling when BUM traffic originating from a leaf-designated host is encapsulated with a leaf indication flag. In the example of FIG. 10, edge network device 10E-1 may receive traffic such as traffic 100 from leaf-designated host 16-1A. Edge network device 10E-1 may forward traffic 100 toward edge network devices 10E-2 and 10E-3 via network 8C in FIG. 3. In particular, after receiving the traffic from host 16-1A, network device 10E-1 may perform ingress replication of the traffic and forward the replicated traffic as traffic 100 to both edge network devices 10E-2 and 10E-3 (and other network devices 10E at the egress side of network 8C).

Based on their locally attached hosts for the same VLAN (e.g., whether one or more local leaf and/or root hosts for the same VLAN are communicatively coupled to the edge device), egress-side edge network devices 10E-2 and 10E-3 may appropriately process (e.g., forward and/or drop) the received BUM traffic 100 to provide segmentation for E-Tree service.

To assist in appropriate processing of BUM traffic 100 at the egress side of network 8C (e.g., at devices 10E-2 and 10E-3), each packet of BUM traffic 100 may include a VXLAN header 102 that has a leaf indication flag 104. In particular, in preparation for traversal across network 8C, network device 10E-1 may perform VXLAN encapsulation for BUM traffic 100 that originated from host 16-1A. Because network device 10E-1 is configured to identify host 16-1A as a leaf-designated host, as part of the encapsulation process, a set leaf indication flag 104 (e.g., a single-bit flag having a set value of ‘1’) may be included in VXLAN header 102.

Prior to the processing of BUM traffic 100, egress edge network devices such as devices 10E-2 and 10E-3 may be configured to determine EVPN role classification of the source host of the traffic based on the leaf indication flag in BUM traffic 100. In particular, based on the flag value being a first set value, the egress edge network device may be configured to determine that the packets of traffic 100 originated from a leaf-designated host belonging to the VLAN.

In an arrangement in which an egress edge network device is coupled or locally attached to local leaf-designated end host(s), the egress network device may decapsulate the VXLAN-encapsulated traffic and drop leaf-sourced BUM traffic 100 to prevent traffic 100 from reaching local leaf-designated host(s) on the same VLAN. Accordingly, in the example of FIG. 10, device 10E-2 may receive BUM traffic 100 but may drop the received BUM traffic 100 such that BUM traffic 100 does not reach host 16-2. This enforces E-Tree service segmentation in which leaf-host-sourced traffic should not reach leaf-designated destination hosts.

In an arrangement in which an egress edge network device is coupled or locally attached to local root-designated end host(s), the egress network device may decapsulate the VXLAN-encapsulated traffic and forward leaf-sourced BUM traffic 100 to the root-designated end host(s) on the VLAN. Accordingly, in the example of FIG. 10, device 10E-3 may receive BUM traffic 100 and may forward the received BUM traffic 100 to host 16-3. This enforces E-Tree service segmentation in which leaf-host-sourced traffic should reach root-designated destination hosts. Since root-designated hosts can receive both leaf and root sourced traffic, in a configuration in which edge network device 10E-3 is attached to only root-designated hosts, device 10E-3 may forward BUM traffic 100 without necessarily examining the value of leaf indication flag 104.

In an arrangement in which an egress network device is coupled or locally attached to both leaf-designated and root-designated local hosts, the egress network device may forward the leaf-sourced BUM traffic 100 to root-designated end host(s) in the VLAN while dropping the BUM traffic 100 such that BUM traffic 100 does not reach leaf-designated end host(s) in the VLAN.

FIG. 11 is a diagram of illustrative traffic handling when BUM traffic originating from a root-designated host is encapsulated with a leaf indication flag. In the example of FIG. 11, edge network device 10E-1 may receive traffic such as traffic 110 from root-designated host 16-1B. Edge network device 10E-1 may forward traffic 110 toward edge network devices 10E-2 and 10E-3 via network 8C in FIG. 3. In particular, after receiving the traffic from host 16-1B, network device 10E-1 may perform replication of the traffic (sometimes referred to as ingress replication since device 10E-1 is at the ingress side of network 8C) and forward the replicated traffic as traffic 110 to both edge network devices 10E-2 and 10E-3 (and other network devices 10E at the egress side of network 8C).

Based on their locally attached hosts for the same VLAN (e.g., whether one or more leaf and/or root hosts for the same VLAN are communicatively coupled to the edge device), edge network devices 10E-2 and 10E-3 may appropriately process (e.g., forward) the received BUM traffic 1100 to provide segmentation for E-Tree service.

To assist in appropriate processing of BUM traffic 110 at the egress side of network 8C (e.g., at devices 10E-2 and 10E-3), each packet of BUM traffic 110 may include a VXLAN header 112 that includes a leaf indication flag 114. In particular, in preparation for traversal across network 8C, network device 10E-1 may perform VXLAN encapsulation for BUM traffic 110 that originated from host 16-1B. Because network device 10E-1 is configured to identify host 16-1B as a root-designated host, as part of the encapsulation process, an unset leaf indication flag 114 (e.g., a single-bit flag having an unset value of ‘0’) may be included in VXLAN header 112.

Prior to the processing of BUM traffic 110, egress edge network devices such as devices 10E-2 and 10E-3 may be configured to determine EVPN role classification of the source host of the traffic based on the leaf indication flag in BUM traffic 110. In particular, based on the flag value being a second unset value, the egress edge network device may be configured to determine that the packets of traffic 110 originated from a root-designated host belonging to the VLAN.

Since traffic originating from root-designated hosts can be received by both leaf-designated and root-designated hosts, in a configuration in which egress edge network devices (e.g., devices 10E-2 and 10E-3) receive root-designated traffic, the egress network devices may forward BUM traffic 110 to its leaf and root end hosts without necessarily identifying that the leaf indication flag has an unset value.

The leaf indication flag as described in connection with FIGS. 10 and 11 may be used instead of the root and leaf VNIs described in connection with FIGS. 5-9. In particular, traffic 100 in FIG. 10 and traffic 110 in FIG. 11 may both be encapsulated with the same VNI (e.g., a default VNI) for the VLAN in the VXLAN header. If desired, the leaf indication flag may be used in addition to the root and leaf VNIs.

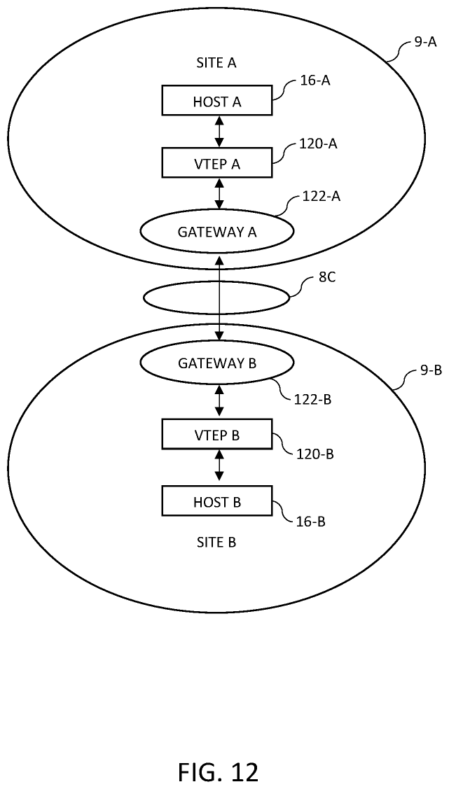

In some arrangements, site gateways may provide connectivity (e.g., may interface) between edge network devices and the corresponding sites (e.g., network devices and hosts within the sites may be behind the gateways). FIG. 12 is a diagram of an illustrative network configuration (e.g., for network 8 in FIG. 1) containing two sites 9-A and 9-B connected by an intervening network such as underlay network 8C in FIG. 1. Configurations in which intervening network 8C implement a datacenter interconnect network and/or a VXLAN network over which EVPN E-tree service is provided are sometimes described herein as an illustrative example.

As shown in FIG. 12, root and leaf hosts in each site such as host 16-A for site 9-A and host 16-B for site 9-B may be behind a corresponding site gateway 122-A or 122-B (e.g., a datacenter interconnect gateway) that receives all local traffic (e.g., both root-sourced and leaf-sourced traffic) from local hosts in the site and receive all remote traffic (e.g., both root-sourced and leaf-sourced traffic) destined to local hosts in the site. A root host may refer to a host locally attached to a virtual tunnel endpoint (VTEP) configured with a root VLAN attachment for the host. A leaf host may refer to a host attached to a VTEP configured with a leaf VLAN attachment for the host.

In the example of FIG. 12, VTEP 120-A may be configured on and implemented using a network device such as an edge network device 10E, or more specifically 10E-1, described in connection with FIGS. 1-11 and VTEP 120-B may be configured on and implemented using a network device such as another edge network device 10E, or more specifically 10E-2 or 10E-3, described in connection with FIGS. 1-11. Accordingly, the edge network devices on which VTEPs 120-A and 120-B are configured may use leaf and root VNIs for indicating leaf-sourced traffic and root-sourced traffic (e.g., as described in connection with FIGS. 5-9) and/or may use an indication flag for indicating leaf-sourced traffic and root sourced traffic (e.g., as described in connection with FIGS. 10 and 11). The network configuration in FIG. 12 is merely illustrative. If desired, additional network devices and/or hosts may also be included in site 9-A, site 9-B, and/or other sites.

To facilitate the use of the mechanism(s) described in connection with FIGS. 5-11 in the network configuration of FIG. 12, which includes intervening gateways 122-A and 122-B, gateways 122-A and 122-B may be configured to preserve VXLAN header information that conveys EVPN role classification of the traffic source host. As an example, when gateway 122-A receives local BUM traffic (e.g., from leaf-designated host 16-A) encapsulated with a VXLAN header including a leaf VNI, gateway 122-A may be configured to ensure that the leaf VNI is preserved when output from gateway 122-A into network 8C. Analogously, when gateway 122-B receive remote BUM traffic (e.g., from gateway 122-A, via network 8C, and with leaf-designated host 16-A as the source host) encapsulated with the VXLAN header including the leaf VNI, gateway 122-B may be configured to ensure that the leaf VNI is preserved when output from gateway 122-B to local network devices (e.g., to VTEP 120-B).

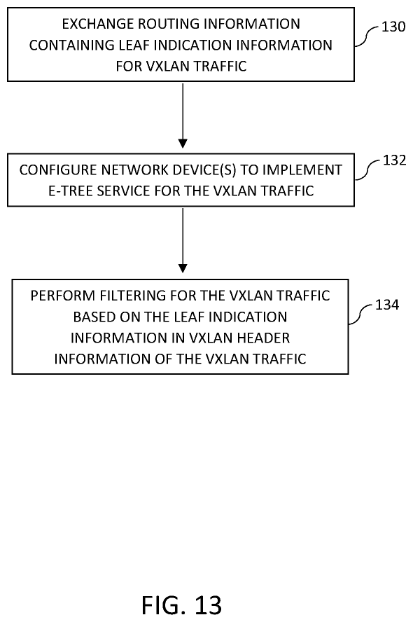

FIG. 13 is a flowchart of illustrative operations performed by one or more edge network devices 10E for conveying routing information and/or providing appropriate network segmentation for VXLAN BUM traffic. These operations in FIG. 13 may be performed using one or more of components of the one or more network devices 10E described in connection with FIGS. 1-12. The illustrative operations described in connection with FIG. 13 may generally be performed using corresponding packet processing circuitry and/or by control plane processing circuitry on these network devices 10E (e.g., by executing, on the processing circuitry, software instructions stored on memory circuitry on network devices 10E).

At block 130, one or more processors (e.g., processing circuitry 28 in FIG. 2 for one or more devices 10E) may exchange routing information containing leaf indication information for processing VXLAN traffic (e.g., BUM traffic encapsulated with a VXLAN header). As one example described in connection with FIGS. 5 and 6, processing circuitry 28 of an ingress-side edge device 10E having locally attached leaf and root hosts may generate advertisement messages for an altered EVPN type-1 or auto-discovery route carrying leaf and/or root indication information (e.g., an EVPN route with default fields associated with an EVPN type-1 route but with values in at least some of the default fields indicating a leaf VNI and an associated VLAN for the leaf VNI). These advertisement messages may be advertised by the ingress-side edge device 10E to one or more egress-side edge devices 10E.

At block 132, the one or more processors (e.g., processing circuitry 28 in FIG. 2 for one or more devices 10E) may configure the network device(s) to implement or otherwise facilitate E-Tree service for any received VXLAN traffic. As one example described in connection with FIGS. 5 and 6, processing circuitry 28 of an egress-side edge device 10E may process the received altered EVPN type-1 route to configure one or more packet processors 32 of the egress-side edge device 10E to appropriately forward and/or drop VXLAN traffic based on the VNI in the VXLAN header.

In illustrative configurations in which a leaf indication flag in the VXLAN header is used, the operations at block 130 may be omitted and processing circuitry 28 of the egress-side edge device 10E may be configured (e.g., based on user input, based on one or more configuration files, etc.) to appropriately forward and/or drop VXLAN traffic based on the leaf indication flag in the VXLAN header.

At block 134, the one or more processors (e.g., processing circuitry 28 and/or packet processors 32 in FIG. 2 for one or more device 10E) may perform filtering for the VXLAN traffic based on the leaf indication information in the VXLAN header information of the VXLAN traffic. As a first example, packet processor(s) 32 of egress-side edge devices 10E may be configured to perform egress filtering as described in connection with FIGS. 7 and 8 based on the VNI in the VXLAN header of the VXLAN traffic. In particular, the packet processor(s) 32 of egress-side edge devices 10E may decapsulate the VXLAN-encapsulated traffic, may compare the VNI in the VXLAN header with a stored version of the VNI advertised at block 130, may determine a VLAN associated with the VNI and corresponding local host devices of the VLAN based on the comparison between the VNI in the VXLAN header and the stored VNI and based on the association between the stored VNI and the VID as advertised, and may selectively forward (e.g., forward and/or drop) the BUM traffic depending on the EVPN role classification of the locally attached hosts.

As a second example, packet processor(s) 32 of an ingress-side edge device 10E may be configured to perform ingress filtering as described in connection with FIG. 9 based on a floodlist for a leaf VNI. As a third example, packet processor(s) 32 of egress-side edge devices 10E may be configured to perform egress filtering as described in connection with FIGS. 10 and 11 based on the leaf indication flag in the VXLAN header of the VXLAN traffic.

The methods and operations described above in connection with FIGS. 1-13 may be performed by the components of the network device(s) and/or server or other computing equipment (e.g., network devices 10E) using software, firmware, and/or hardware (e.g., dedicated circuitry or hardware). Software code for performing these operations may be stored on non-transitory computer-readable storage media (e.g., tangible computer-readable storage media) stored on one or more of the components of the network device(s) and/or server or other computing equipment. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s) and/or server or other computing equipment (e.g., processing circuitry 28 in FIG. 2, packet processor(s) 32 in FIG. 2, etc.).

The foregoing is merely illustrative and various modifications can be made to the described embodiments. The foregoing embodiments may be implemented individually or in any combination.

What is claimed is:

1. A method of conveying Ethernet Virtual Private Network (EVPN) routing information, the method comprising:
advertising, by a EVPN network device, an EVPN Auto-Discovery (A-D) route toward one or more peer EVPN network devices,
wherein the EVPN A-D route comprises a Virtual Extensible Local Area Network (VXLAN) network identifier indicative of leaf-sourced network traffic or root-sourced network traffic, and
wherein the EVPN A-D route comprises an Ethernet Tag Identifier (ETID) field having a value of a Virtual Local Area Network (VLAN) identifier associated with the VXLAN network identifier (VNI).

2. The method defined in claim 1, wherein the EVPN A-D route comprises an E-tree extended community having a field with the VNI as a value of the field of the E-tree extended community.

3. The method defined in claim 2, wherein the EVPN A-D route comprises an Ethernet Segment Identifier (ESI) field having a value of zero.

4. The method defined in claim 1, wherein the VNI is indicative of the leaf-sourced network traffic and wherein the VNI is a leaf VNI.

5. The method defined in claim 4 further comprising:
receiving, by the EVPN network device and from a leaf-designated host, broadcast, unknown unicast, or multicast (BUM) traffic, wherein the leaf-designated host is locally attached to the EVPN network device and is a member of the VLAN identified by the VLAN identifier (VID);
encapsulating the BUM traffic with a VXLAN header containing the leaf VNI; and
outputting the encapsulated BUM traffic toward the one or more peer EVPN network devices.

6. The method defined in claim 4 further comprising:
receiving, by the EVPN network device and from a root-designated host, broadcast, unknown unicast, or multicast (BUM) traffic, wherein the root-designated host is locally attached to the EVPN network device and is a member of the VLAN identified by the VLAN identifier (VID);
encapsulating the BUM traffic with a VXLAN header containing a root VNI different from the leaf VNI; and
outputting the encapsulated BUM traffic toward the one or more peer EVPN network devices.

7. The method defined in claim 4 further comprising:
maintaining a floodlist for the leaf VNI, wherein the floodlist identifies one or more peer EVPN network devices having one or more local root-designated hosts and in the one or more peer EVPN network devices.

8. The method defined in claim 7 further comprising:
receiving, by the EVPN network device and from a leaf-designated host, broadcast, unknown unicast, or multicast (BUM) traffic, wherein the leaf-designated host is locally attached to the EVPN network device and is a member of the VLAN identified by the VLAN identifier (VID);
encapsulating the BUM traffic with a VXLAN header containing the leaf VNI; and
outputting the encapsulated BUM traffic toward the one or more peer EVPN network devices identified by the floodlist.

9. The method defined in claim 1, wherein the EVPN network device is locally attached to at least one leaf-designated host and at least one root-designated host.

10. The method defined in claim 1, wherein the EVPN network device is coupled to the one or more peer EVPN network devices via a core network configured to forward VXLAN traffic between the EVPN network device and the one or more peer EVPN network device.

11. A method of processing Ethernet Virtual Private Network (EVPN) routing information, the method comprising:
receiving, by a EVPN network device and from a peer EVPN network device, an EVPN Auto-Discovery (A-D) route, wherein the EVPN A-D route comprises a Virtual Extensible Local Area Network (VXLAN) network identifier indicative of leaf-sourced network traffic or root-sourced network traffic and wherein the EVPN A-D route comprises an Ethernet Tag Identifier (ETID) field having a value of a Virtual Local Area Network (VLAN) identifier associated with the VXLAN network identifier (VNI);
storing the VNI and the VLAN identifier (VID) associated with the VNI;
receiving encapsulated broadcast, unknown unicast, or multicast BUM traffic having a VXLAN header with an VNI;
decapsulating the received encapsulated BUM traffic; and
selectively forwarding the BUM traffic based on a comparison between the VNI in the VXLAN header and the stored VNI.

12. The method defined in claim 11, wherein the EVPN network device has a plurality of locally attached hosts and wherein selectively forwarding the BUM traffic based on a comparison between the VNI in the VXLAN header and the stored VNI comprises determining one or more locally attached hosts in the plurality of locally attached hosts that are part of a VLAN identified by the VID based on the comparison between the VNI in the VXLAN header and the stored VNI and based on the association between the stored VNI and the VID.

13. The method defined in claim 11, wherein the stored VNI is indicative of the leaf-sourced network traffic and wherein the stored VNI is a leaf VNI.

14. The method defined in claim 13, wherein the EVPN network device has a locally attached leaf-designated host and wherein selectively forwarding the BUM traffic based on the comparison between the VNI in the VXLAN header and the stored VNI comprises preventing forwarding of the BUM traffic to the locally attached leaf-designated host based on the VNI in the VXLAN header matching the stored VNI.

15. The method defined in claim 13, wherein the EVPN network device has a locally attached leaf-designated host and wherein selectively forwarding the BUM traffic based on the comparison between the VNI in the VXLAN header and the stored VNI comprises forwarding the BUM traffic to the locally attached leaf-designated host based on the VNI in the VXLAN header being different from the stored VNI.

16. The method defined in claim 13, wherein the EVPN network device has a locally attached root-designated host and wherein selectively forwarding the BUM traffic based on the comparison between the VNI in the VXLAN header and the stored VNI comprises forwarding the BUM traffic to the locally attached root-designated host.

17. The method defined in claim 11, wherein the EVPN A-D route comprises an E-tree extended community having a field with the stored VNI as a value of the field of the E-tree extended community and wherein the EVPN A-D route comprises an Ethernet Segment Identifier (ESI) field having a value of zero.

18. A method of operating an Ethernet Virtual Private Network (EVPN) network device to forward traffic toward one or more peer EVPN network devices via a core network, the method comprising:
receiving, by the EVPN network device and from a leaf-designated host, broadcast, unknown unicast, or multicast (BUM) traffic, wherein the leaf-designated host is locally attached to the EVPN network device and is a member of a Virtual Local Area Network (VLAN) identified by a VLAN identifier (VID);
encapsulating the BUM traffic with a Virtual Extensible Local Area Network (VXLAN) header containing a leaf indication flag, the leaf indication flag having a value indicative of leaf-sourced traffic; and
outputting the encapsulated BUM traffic toward the one or more peer EVPN network devices.

19. The method defined in claim 18 further comprising:
receiving, by the EVPN network device and from a root-designated host, additional BUM traffic, wherein the root-designated host is locally attached to the EVPN network device and is a member of the VLAN identified by the VID;
encapsulating the additional BUM traffic with a VXLAN header containing a leaf indication flag, the leaf indication flag having a value indicative of root-sourced traffic; and
outputting the encapsulated additional BUM traffic toward the one or more peer EVPN network devices.

20. The method defined in claim 19, wherein the VXLAN header of the encapsulated BUM traffic contains a VXLAN network identifier (VNI) associated with the VID and wherein the VXLAN header of the encapsulated additional BUM traffic contains the VNI.
